(19) United States
(12) Patent Application Publication
(10) Pub. No.: US 2005/0205824 A1
(43) Pub. Date: Sep. 22, 2005

(54) Segmented ball control valve with universal end connections

(76) Inventor: Charles Agnew Osborne, Cumming, GA (US)

Correspondence Address: WOMBLE CARLYLE SANDRIDGE & RICE, P.O. Box 7037, Atlanta, GA, 30357-0037, US

(21) Appl. No.: 10/878,078

(22) Filed: Jun. 28, 2004

Related U.S. Application Data
(60) Provisional application No. 60/554,315, filed on Mar. 18, 2004.

(51) Int. Cl. F16K 5/06

(52) U.S. Cl. 251/305

(57) ABSTRACT

A segmented ball control valve assembly for controlling fluid flowing in a piping system having a ball valve seat retainer rigidly affixed to the valve body and providing universal end connections. The universal end connections include both a screw-type end connection and a wafer-type end connection. The segmented ball control valve can be used without modification in a threaded NPT piping system or a flanged piping system. The wafer-type connection is provided by the rigidly affixed ball valve seat retainer on the inlet end of the valve assembly. A ball valve seat isolates the ball valve body from the ball valve seat retainer. A solid graphite seat provides the primary sealing component between the ball and ball valve seat.

### CROSS-REFERENCE TO RELATED APPLICATION

The present patent application is a formalization of a previously filed, co-pending provisional patent application entitled “Segmented Ball Control Valve with Universal End Connections,” filed Mar. 18, 2004, as U.S. Patent Application Ser. No. 60/554,315. This patent application claims the benefit of the filing date of the cited provisional patent application according to the statutes and rules governing provisional patent applications, particularly 35 U.S.C. § 119(e)(1) and 37 CFR §§ 1.78(a)(4) and (a)(5). The specification and drawings of the provisional patent application are specifically incorporated herein by reference.

### BACKGROUND OF THE INVENTION

The present invention relates generally to segmented ball control valves, and more particularly, to segmented ball control valves providing integral universal end connections.

In the prior art, segmented ball control valves with wafer type connection capability are known. However, the prior art fails to teach a segmented ball control valve having screw-type end connections. More significantly, the prior art fails to teach a segmented ball control valve having universal end connections that can be adapted to either wafer type or screw type connection usages without modification to the valve. The prior art further fails to teach a segmented ball control valve having wafer type connections with a bolted on seat retainer.

A segmented ball control valve is a fluid valve using a valve body with an inlet and outlet flow passage and a control element internal to the valve body and inline with the flow passages. The segmented ball valve control element is connected to a shaft which is used to rotate it through a 90° arc to open and close the valve. The V-notch ball is the most common type of segmented ball control valve. The V-notch ball includes a convex and concave side producing a bowl shape with a defined V-shaped opening to control and characterize the fluid flow. The segmented ball may be polished or plated and rotates against the seal ring throughout the range of travel. Current segmented ball control valve sizes range from 1 to 24 inches.

The current valve body end connection types use integral flanges or are of a wafer type. The integral flanges are cast into the body at the foundry. A valve body with integral flanges is designed to be directly coupled to matching pipe flanges of the same size, type and pressure rating. This type end connection is limited in use with piping systems using flanged pipe connections and may only be used if an existing piping system with flanged end connections is changed or a new piping system is designed to have flanged end connections. A modification in an existing piping system or design of a new one to use flanged end connections will add additional costs to the piping system. A wafer-type valve body design does not have integrally cast flanges and is also described as a flangeless valve body style. The wafer or flangeless valve is held between American National Standards Institute (ANSI) class flanges by long through bolts.

### SUMMARY OF THE INVENTION

The universal end connection capability of the present invention provides a wide range of benefits for everyone from the manufacturer to the end user. The ability of a single valve body assembly to accommodate both a National Pipe Thread (NPT) threaded connection as well as a variety of American National Standards Institute (ANSI) raised face flange connections (e.g., ANSI 150 & 300) or flat face flange connections (e.g., ANSI 125 & 250) produces a true multi-purpose valve. The bolted on inlet connection seat retainer and the valve outlet connection are drilled and tapped to accept male NPT threads as well as being finished to accept the aforementioned ANSI flanges with a smooth finish designation.

Novel features of the segmented ball control valve of the present invention also include the use of a solid graphite ball seat. The ball seat contacts the segmented ball control element to provide the sealing surface to stop the flow of fluid from the inlet to the outlet, and also acts as the gasket between the valve body and ball valve seat retainer. A further novel feature is the use of screw-type end connections with a segmented ball control valve. Heretofore, all segmented ball control valves have used flanged connections only.

In one aspect of the invention there is provided a segmented ball control valve assembly for controlling fluid flowing in a piping system including a valve body and a ball valve seat retainer rigidly affixed to the valve body and providing universal end connections. The universal end connections include both a screw-type end connection and a wafer-type end connection. The segmented ball control valve of the present invention can be used without modification in a threaded NPT piping system or a flanged piping system. The wafer-type connection is provided by the rigidly affixed ball valve seat retainer on the inlet end of the valve assembly. A ball valve seat isolates the ball valve body from the ball valve seat retainer. A solid graphite seat provides the primary sealing component between the ball and ball valve seat.

### BRIEF DESCRIPTION OF THE DRAWINGS

The invention is better understood by reading the following detailed description of the invention in conjunction with the accompanying drawings.

FIG. 1A illustrates a side cross sectional (partial) view of the segmented ball control valve assembly of the present invention.

FIG. 1B illustrates an elevation view of the of the segmented ball control valve of the present invention.

FIG. 1C illustrates a partial view of the seat retainer of the present invention.

FIGS. 2A-2C illustrate plan and sectional views of the body for the segmented ball control valve assembly of the present invention.

FIG. 3A-3C illustrate a plan view, a sectional view and an enlarged view of the seat retainer for the segmented ball control valve of the present invention.

FIGS. 4A-4B illustrate a plan view and an enlarged view of the graphite seat for the segmented ball control valve of the present invention.

FIG. 5 illustrates a perspective view of the assembled segmented ball control valve in a flanged piping system.

FIG. 6 illustrates a perspective view of the assembled segmented ball control valve in a threaded piping system.

FIG. 7 illustrates a cutaway view of the segmented ball control valve of FIG. 5.

FIG. 8 illustrates a cutaway view of the segmented ball control valve of FIG. 6.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

The universal end connection capability of the invention provides a wide range of benefits for everyone from the manufacturer to the end user of segmented ball control valves. The ability of a single valve body assembly to accommodate a National Pipe Thread (NPT) threaded connection as well as a variety of American National Standards Institute (ANSI) raised face flange connections (ANSI 150 & 300) or flat face flange connections (ANSI 125 & 250) produces a novel segmented ball control valve. Both the bolted on inlet connection seat retainer and the valve outlet connection are drilled and tapped to accept male NPT threads, and are finished to accept the aforementioned ANSI flanges with a smooth finish designation.

Precise contouring of the segmented ball provides an equal percentage flow characteristic for excellent fluid flow control while the unrestricted straight-through flow design provides high capacity for increased rangeability.

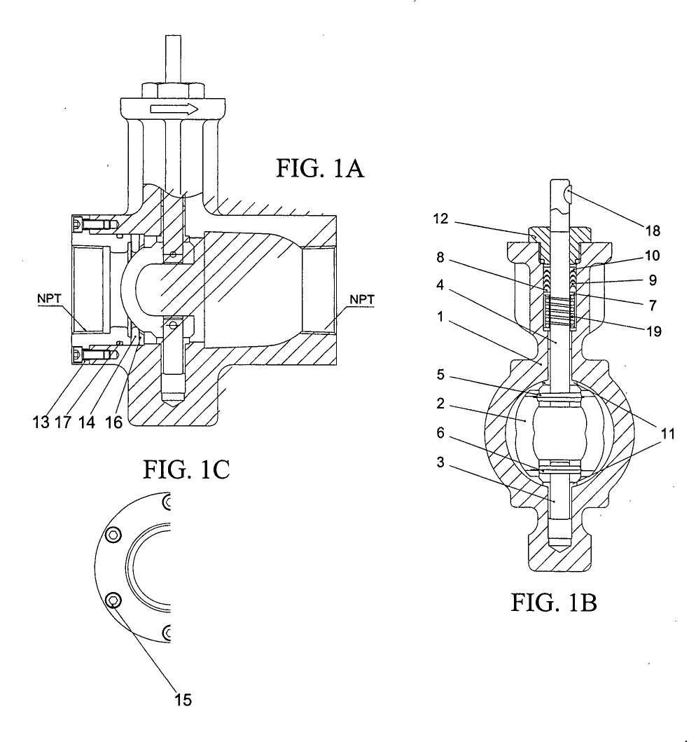

FIGS. 1A-1B illustrate a side cross sectional (partial) view and an elevation section view of the segmented ball control valve assembly, respectively. The assembly components are identified by part name and reference numeral. In the embodiment disclosed in FIGS. 1A-1B, the complete segmented ball control valve assembly contains a number of distinct parts as noted. Specific to this invention are ball valve body 1, ball valve seat retainer 13 and ball valve seat 14. The complete identification of the assembly parts includes packing spring 19, Woodruff key 18, seat retainer seal 17, gasket ring 16, seat retainer bolts 15, ball valve seat 14, ball valve seat retainer 13, ball valve packing flange 12, shaft guide 11, packing follower 10, packing ring 9, packing ring 8, packing washer 7, pin taper 6, taper pin 5, drive shaft 4, follower shaft 3, segmented ball 2, and valve body 1. FIG. 1C illustrates a partial view of the seat retainer 13 showing seat retainer bolts 15.

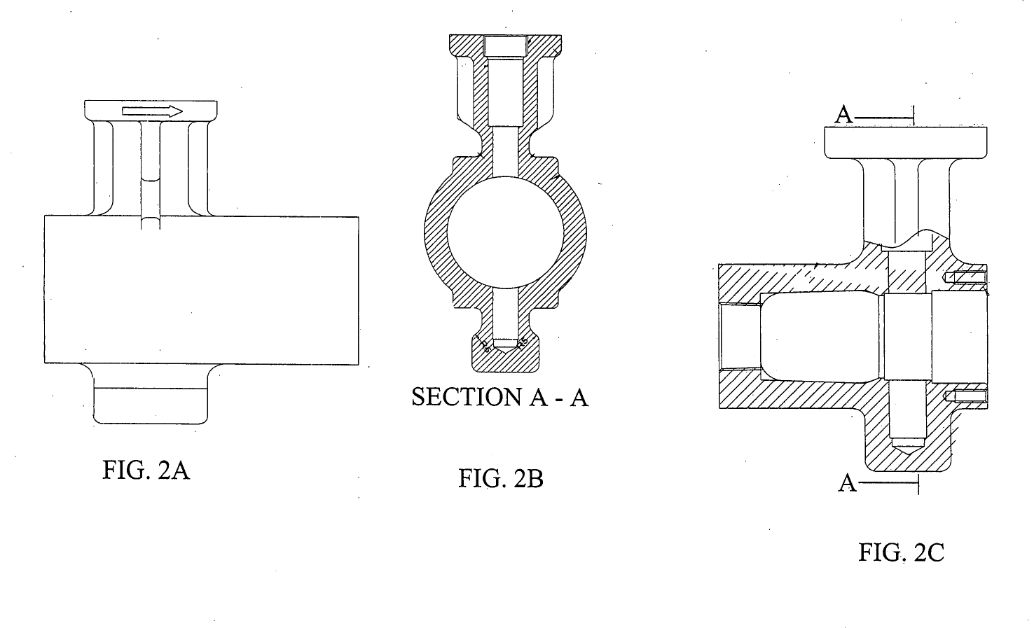

FIGS. 2A-2C illustrate a plan view and sectional views of ball valve body 1 of FIG. 1. The inlet flow passage of the valve body casting is drilled and tapped to accept seat retainer (e.g., Wrench) bolts 15, which retain ball valve seat retainer 13. The mating surface between ball valve body 1 and ball valve seat retainer 13 requires no gasket for fluid retention by design and embodies an additional inventive feature of the invention. Ball valve seat 14 is used as the seal to isolate the valve inlet and outlet flow passages when in the closed position and is used as the gasket to isolate the ball valve body 1 and the ball valve seat retainer 13. The outlet flow passage is prepared with a flange finish that is comparable to a 125-250 rms (root-mean squared) surface as specified by ASME Y14.36M-1996, a national standard published by the American Society of Mechanical Engineers that establishes the method to designate controls for surface texture of solid materials. The flange finish inner and outer diameters are compatible with ANSI 150 & 300 or ANSI 125 & 250 flanges.

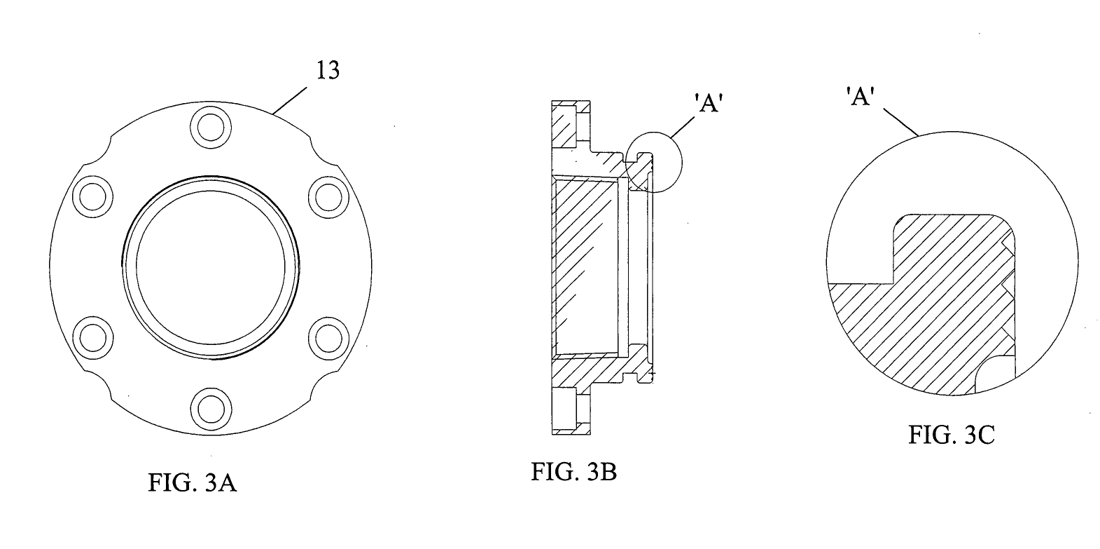

FIGS. 3A-3C illustrate a plan view, sectional view and an enlarged view of the ball valve seat retainer 13 of the invention. The ball valve seat retainer 13 is a novel feature of the invention and allows the valve to be installed in both threaded and flanged piping systems. The part is drilled and tapped to accept mail National Pipe Threads. The seat retainer 13 is rigidly fastened to the ball valve body 1 by seat retainer bolts 15. The seat retainer outer flange mating surface is prepared with a flange finish that is comparable to a 125-250 rms surface as specified by ASME standard Y14.36M-1996. The flange finish inner and outer diameters are compatible with ANSI 150 & 300 or ANSI 125 & 250 flanges. The part detail as designated by the enlarged area “A” is grooved to mate with ball valve seat 14. The design of the mating surface between ball valve seat retainer 13 and ball valve seat 14 in conjunction with the design and materials used for ball valve seat 14 are additional design features of this invention. This design provides for a wafer type valve that can be installed in a flanged piping system, removed and re-installed in the flanged piping system without the need to replace an internal gasket as is common with other segmented ball control valves.

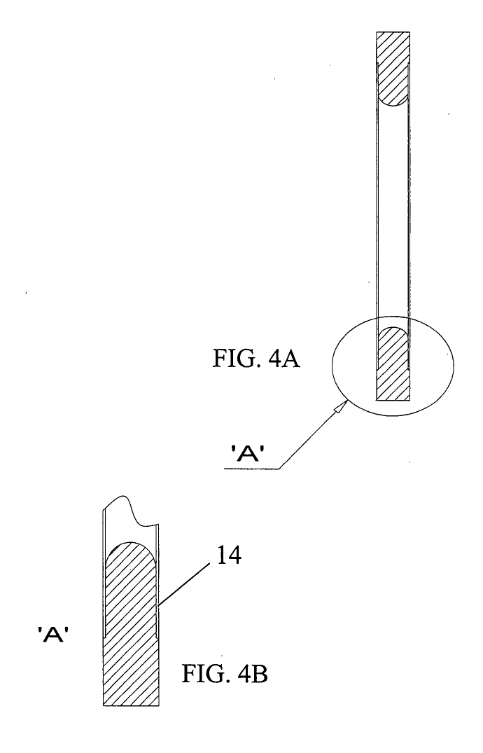

FIGS. 4A-4B illustrate a plan view and an enlarged view of the graphite ball valve seat 14 of the invention. Ball valve seat 14 is machined from a solid graphite block. The use of a solid graphite seat is a unique component of this invention and demonstrates an additional design feature of the invention. The use of the solid graphite material and close machining tolerances minimize deformation of the ball valve seat during compression between ball valve body 1 and ball valve seat retainer 13. This feature allows for ball valve seat retainer 13 to be rigidly fastened to ball valve body 1 by seat retainer bolts 15 with a sufficient axial load to seal the mating surface between these parts and provide for the seal between ball valve seat 14 and ball 2 without an increase in the torque required to open and close the valve.

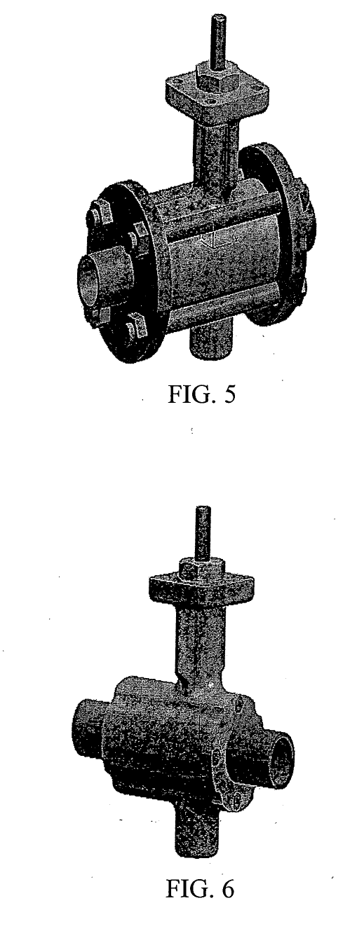

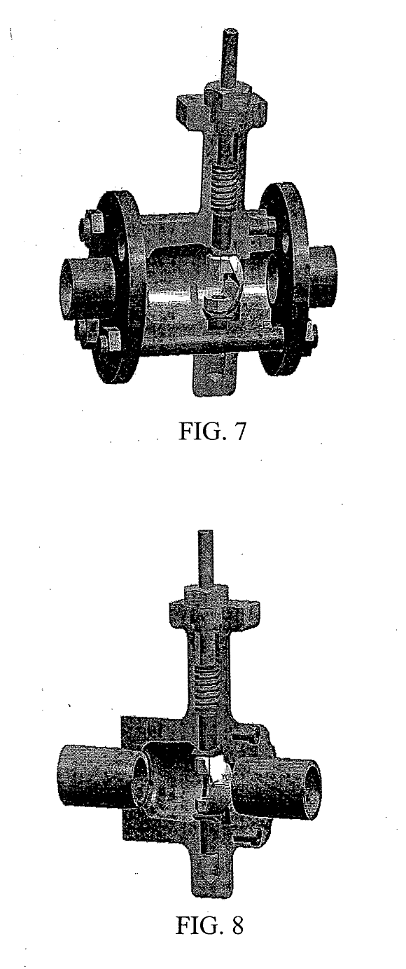

FIG. 5 illustrates a perspective view of the assembled segmented ball control valve with universal connections as it would be installed as a wafer valve in a flanged piping system. FIG. 6 illustrates a perspective view of the assembled segmented ball control valve with universal connections as it would be installed in a NPT threaded piping system. FIGS. 7-8 illustrate cutaway views of the segmented ball control valve corresponding to the perspective views of FIGS. 5-6, respectively. The cutaway views show the stainless steel ball and stem, packing and packing spring, segmented ball, seat retainer and ball seat.

Some additional features of the invention are described in the following paragraphs. Foremost among the features specified below is the installation versatility that the invention provides. The wafer body design can be installed between a variety of ANSI raised-face/flat-faced flange connections including ANSI Class 150 and 300/ANSI Class 125 and 250, respectively. The threaded connection design can accommodate male NPT threaded requirements. The versatility and flexibility that the segmented ball control valve of the invention provides represents a significant addition to the entire valve market.

Another feature of the invention is application suitability. For example, an ANSI Class 300 rated body with a graphite ball seat allows the valve to be used in general service control or in on/off type applications up to 300 psig saturated steam at 428 degrees F. Control valves are designed to throttle, and provide at least some shutoff capability. The solid graphite seat acts as a low torque seal between the ball and seat while providing for the specified ANSI Class VI leakage rate and acting as the gasket between the body and ball valve seat retainer. Class VI is known as a “soft seat” classification, and applies when the seat is made from a composition material.

Another feature of the invention is structural integrity. The one piece valve body improves structural integrity by eliminating leak paths in the body gaskets found in two-piece, bolted valve designs that could be caused by thermal cycling, pressure pulsations, line vibration or poor maintenance practices. The bolted on seat retainer allows the valve to be removed from the line and reinstalled, when installed using the wafer connections, without the need to replace a “seal retainer gasket” as is used by other wafer designs. A seal retainer gasket requires a compressive load provided by the flange bolting to provide a positive seal between the seal retainer and body-mating surface. The gasket is not reusable and manufacturers recommend replacement of the gasket before the valve is reinstalled.

In addition to the features mentioned above, the invention provides a number of significant advantages over commercially available segmented ball control valves. These advantages include lower installation costs, lower manufacturing costs, and lower distribution costs. Use of screw-type end connections for segmented ball control valves reduces the need for line flanges in pipe sizes up to two inches resulting in both lower material and installation costs. Because the invention is directed to a single valve body assembly, the manufacturing process requires fewer molds, fewer tools, lower inventory levels, and fewer, but longer, runs. This results in less setup time overall. The valve packaging and shipping costs are also lower due to the versatility provided by each single valve body assembly. Distribution costs are lower since lower inventory levels can be maintained due to the versatility of the individual valve with universal end connections and a multi-rated body.

The versatility of the individual valve body enables its use in almost any general service industrial or commercial application resulting in a larger coverage of multiple markets and increased distribution of the segmented ball control valve with universal end connections.

The invention includes a self adjusting spring loaded Teflon v-ring packing that provides a superior seal to current O-ring designs. The packing provides a consistent load on the packing box and reduces the need for periodic maintenance to adjust the packing.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments of the present invention are possible without departing from the spirit and scope of the present invention.

1. A segmented ball control valve assembly for controlling fluid flowing in a piping system, comprising:
a valve body; and
a ball valve seat retainer rigidly affixed to the valve body and providing universal end connections.

2. The segmented ball control valve assembly of claim 1 wherein the universal end connections comprise a screw-type end connection.

3. The segmented ball control valve assembly of claim 1 wherein the universal end connections comprise a wafer-type end connection.

4. The segmented ball control valve assembly of claim 1 further comprising a ball valve seat to isolate the valve body and the ball valve seat retainer.

5. The segmented ball control valve assembly of claim 2 wherein the type of end connection used depends on an intended installation of the valve assembly.

6. The segmented ball control valve assembly of claim 2 wherein the screw-type end connection is used with a threaded NPT piping system.

7. The segmented ball control valve assembly of claim 3 wherein the wafer-type end connection is used with a flanged piping system.

8. The segmented ball control valve assembly of claim 1 wherein the seat retainer is bolted on to the valve body.

9. The segmented ball control valve assembly of claim 1 wherein the seat retainer enables the valve assembly to be installed, removed from a flanged piping system, and re-installed without use or replacement of a seal retainer gasket.

10. The segmented ball control valve of claim 4 wherein the ball valve seat comprises solid graphite.

11. The segmented ball control valve of claim 2 wherein the seat retainer and a valve outlet connection are drilled and tapped to accept male NPT threads and finished to accept an ANSI standard flange with a smooth finish designation.

12. The segmented ball control valve of claim 11 wherein the wafer finish is comparable to a surface finish from about 125 root mean square (rms) to about 250 rms.

13. A segmented ball control valve assembly for controlling fluid flowing in a piping system, comprising a valve body; and universal end connections providing interchangeable use of the valve assembly in a plurality of piping systems without modification to the valve assembly.

14. The segmented ball control valve assembly of claim 13 wherein the segmented control valve can be used in a threaded piping system or a flanged piping system.

15. The segmented ball control valve assembly of claim 13 wherein the universal end connections are provided by a ball valve seat retainer rigidly affixed to the valve body.

16. The segmented ball control valve assembly of claim 13 wherein the universal end connections comprise a screw-type end connection.

17. The segmented ball control valve assembly of claim 13 wherein the universal end connections comprise a wafer-type end connection.

18. The segmented ball control valve assembly of claim 13 further comprising a graphite ball valve seat.

19. A segmented ball control valve assembly for controlling fluid flowing in a threaded piping system, comprising a valve body; and a ball valve seat retainer rigidly affixed to the valve body and including a screw-type end connection.

20. The segmented ball control valve assembly of claim 19 wherein the seat retainer is bolted on to the valve body.

21. The segmented ball control valve assembly of claim 19 further comprising a graphite ball valve seat.

22. The segmented ball control valve assembly of claim 19 wherein the piping system is a threaded NPT piping system.

23. A segmented ball control valve assembly for controlling fluid flowing in a piping system, comprising:
a valve body;
a ball valve seat retainer rigidly fastened to the valve body, wherein the seat retainer provides both a screw-type and a wafer-type end connection; and
a graphite ball valve seat that functions as a gasket between the valve body and seat retainer.
